(19) United States
(12) Patent Application Publication
(10) Pub. No.: US 2014/0092737 A1
(43) Pub. Date: Apr. 3, 2014

(54) TRAFFIC CONTROL METHOD AND TRAFFIC CONTROL APPARATUS

(71) Applicants: Haibin Luo, Shanghai (CN); Wei Qiu, Shanghai (CN); Jian Cui, Shanghai (CN)

(72) Inventors: Haibin Luo, Shanghai (CN); Wei Qiu, Shanghai (CN); Jian Cui, Shanghai (CN)

(73) Assignee: ALCATEL LUCENT, Paris (FR)

(21) Appl. No.: 14/122,827

(22) PCT Filed: May 22, 2012
(86) PCT No.: PCT/IB2012/001075

§ 371 Date: Nov. 27, 2013

(30) Foreign Application Priority Data
Jun. 1, 2011 (CN) 201110146568.0

(51) Int. Cl. H04L 12/911

(52) U.S. Cl. CPC H04L 47/822
USPC 370/232

(57) ABSTRACT

The present invention discloses a traffic control method and a traffic control apparatus. The traffic control method comprising the steps of collecting key performance indexes of a system; and determining whether to limit requests entering into the system based on the collected key performance Indexes of the system, and it is determined that the requests entering into the system will be limited when a certain collected key performance Index of the system is inferior to a first threshold for a period of time, According to the invention, traffic control may be effectively, practically and flexibly provided to a system.

### TECHNICAL FIELD

The present invention relates to field of information processing, more particularly, to a traffic control method and a traffic control apparatus.

### DESCRIPTION OF THE RELATED ART

Various systems such as a communication system should be kept in stable and healthy status while supporting the huge traffic brought by different types of requests.

During a certain specific time period, for example, Christmas or New Year's Day, user traffic will increase sharply, probably affecting system's stability or even bringing a system down and not being able to provide service normally.

Thus, traffic control is needed so as to keep a system stable.

However, if traffic control is conducted inappropriately, resources of a system will be under-utilized, thus creating waste.

Therefore, what is needed is an effective, practical and flexible traffic control solution, wherein ‘effective’ means a system is kept as stable as possible, ‘practical’ means system resource is utilized as adequate as possible, and ‘flexible’ means customization of traffic control is conducted according to specific condition as much as possible.

### SUMMARY OF THE INVENTION

According to a first aspect of the invention, there is provided a traffic control method, comprising the steps of: collecting key performance indexes of a system; and determining whether to limit requests entering into the system based on the collected key performance indexes of the system, and it is determined that the requests entering into the system will be limited when a certain collected key performance index of the system is inferior to a first threshold for a period of time.

According to a second aspect of the invention, there is provided a traffic control apparatus, comprising: a collector for collecting key performance indexes of a system; and a determining module for determining whether to limit requests entering into the system based on the collected key performance indexes of the system, and determines that the requests entering into the system will be limited when a certain collected key performance index of the system is inferior to a first threshold for a period of time.

According to the invention, traffic control may be effectively, practically and flexibly provided to a communication system.

### BRIEF DESCRIPTION OF THE DRAWINGS

Other objects and effect of the invention will become more clear and comprehensive from the following description in conjunction with drawings and with the full understanding of the invention, in which:

FIG. 1 illustratively shows a flowchart of a traffic control method according to an embodiment of the invention;

FIG. 2 illustratively shows a block diagram of a traffic control apparatus according to an embodiment of the invention;

FIG. 3 illustratively shows a communication system in which the invention may be implemented.

Same reference number represents same, similar or corresponding feature or function throughout the above drawings.

### DETAILED DESCRIPTION OF THE PREFERRED EMBODIMENT

The basic idea of the invention is to determine whether to limit requests entering into a system based on Key Performance Indexes KPIs of the system.

KPI is the most intuitive index that reflects health condition of a system, it includes indexes about system hardware resources, such as CPU utilization, memory utilization, hard disk read/write utilization etc, as well as indexes defined by software logic concept, such as length of a queue, size of an available pool etc. Whether requests entering into a system will be limited may be reasonably determined by constantly collecting KPIs of the system, that is, resources of the system are made to be utilized as adequately as possible while keeping the system stable.

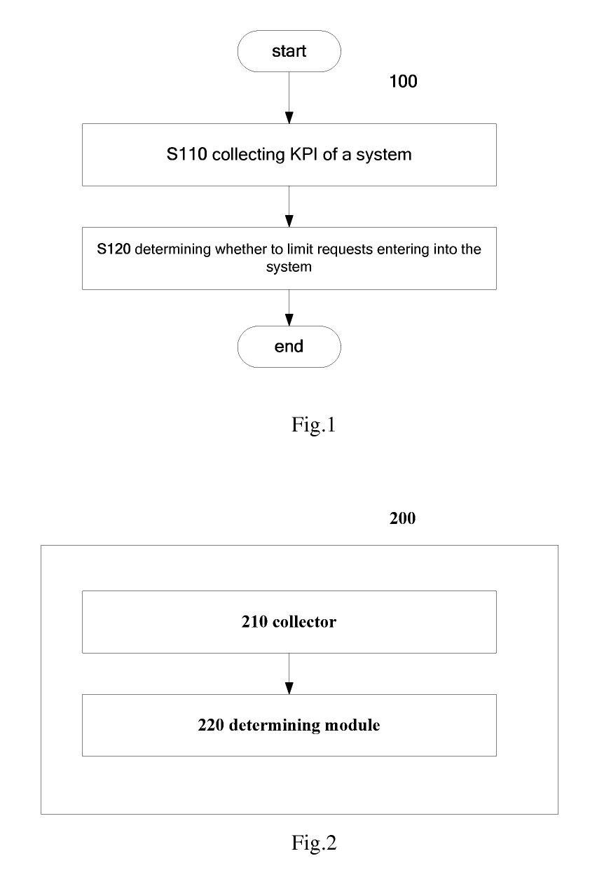

FIG. 1 illustratively shows a flowchart of a traffic control method according to an embodiment of the invention.

As shown in FIG. 1, the method 100 comprises step S110 of collecting KPIs of a system; and step S120 of determining whether to limit requests entering into the system based on the collected KPIs of the system, and it is determined that the requests entering into the system will be limited when a certain collected KPI of the system is inferior to a first threshold for a period of time.

Accordingly, FIG. 2 illustratively shows a block diagram of a traffic control apparatus according to an embodiment of the invention.

As shown in FIG. 2, the traffic control apparatus 200 comprises: collector 210 for collecting KPIs of a system; and determining module 220 for determining whether to limit requests entering into the system based on the collected KPIs of the system, and determines that the requests entering into the system will be limited when a certain collected KPI of the system is inferior to a first threshold for a period of time.

For example, a certain collected KPI of the system may be Average CPU Utilization, the first threshold may be 80%, in case that Average CPU Utilization is superior to the first threshold, namely, in case that Average CPU Utilization is less than or equal to 80%, the system still can operate stably, and there is no need to limit requests entering into the system.

In case that Average CPU Utilization is inferior to the first threshold, namely, in case that Average CPU Utilization is larger than 80%, meaning load of the system is too heavy and system may be unstable, thus, at the determining step S120 and the determining module 220, it is determined that the requests entering into the system will be limited when Average CPU Utilization is larger than 80% for 5 minutes.

Wherein, limiting the requests comprises randomly rejecting a certain proportion of the requests at entry points where the requests enter into the system, that is, fail response will be returned to some requests, rather than deliver these requests to internal of the system for processing. For example, reject rate may be 20%, that is to say, on average, 2 requests out of 10 requests entering into the system will be rejected.

Such a policy may make user experience relative good, since only a few user requests will be rejected, while most user requests get served.

Wherein, at the determining step S120 and the determining module 220, for requests entering into the system from different interfaces, whether to limit the requests entering into the system from respective interfaces may be determined by using different collected KPIs of the system.

For example, for requests entering into a system via an Open IVR (Interactive Voice Response) interface, such a system KPI as CPU Utilization may be employed, if Average CPU Utilization is larger than 80% for 5 minutes, then it may be determined to limit requests entering into the system via the Open IVR interface, for example, the requests entering into the system via the Open IVR interface may be rejected with a reject rate of 20%.

For requests entering into a system via a SMS (Short Message Service) interface, such a system KPI as length of a queue may be employed, if average length of a queue is larger than 20 for 5 minutes, then it may be determined to limit requests entering into the system via the SMS interface, for example, the requests entering into the system via the SMS interface may be rejected with a reject rate of 50%.

Such a policy takes into account the fact that requests entering into a system from different interfaces may influence different KPIs of the system. For example, requests entering into the system via the Open IVR interface mainly consume system's CPU resource, and thus mainly influence such KPI as Average CPU Utilization of the system, while requests entering into the system via the SMS interface mainly consume system's queue resource, and thus mainly influence such KPI of the system as average length of a queue.

Wherein, at the determining step S120 and the determining module 220, for requests entering into the system from different interfaces, whether to limit the requests entering into the system from respective interfaces may be determined by using same collected KPIs of the system but by using different thresholds.

For example, for requests entering into a system via an Open IVR (Interactive Voice Response) interface, such a KPI as Average CPU Utilization and such a threshold as 80% may be employed to determine whether to limit requests entering into the system via the Open IVR interface. If Average CPU Utilization is larger than 80% for 5 minutes, then it may be determined to limit requests entering into the system via the Open IVR interface, for example, the requests entering into the system via the Open IVR interface may be rejected with a reject rate of 10%.

For requests entering into a system via a SMS (Short Message Service) interface, such a KPI as Average CPU Utilization and such a threshold as 70% may be employed to determine whether to limit requests entering into the system via the SMS interface. If Average CPU Utilization is larger than 70% for 5 minutes, then it may be determined to limit requests entering into the system via the SMS interface, for example, the requests entering into the system via the SMS interface may be rejected with a reject rate of 50%.

Such a policy may perform differentiated processing on requests entering into a system from different interfaces, so that requests with low priority may be limited first, and limited available system resources are used to serve more requests with high priority. Requests with high priority will be limited only when merely limiting requests with low priority still can not lower system load. That is to say, requests entering into a system via a SMS interface with low priority will be limited upon Average CPU Utilization is larger than 70% for 5 minutes, while requests entering into a system via an Open IVR interface with high priority will not be limited unless Average CPU Utilization is larger than 80% for 5 minutes.

Wherein, at the determining step S120 and the determining module 220, for different systems, whether to limit requests entering into the systems may be determined by using different collected KPIs of the systems.

If a system needs to perform intensive floating point computation (e.g., the system is a prepay billing system), since floating point computation is CPU resource intensive, whether to limit requests entering into the system may be determined by using such system KPI as system's Average CPU Utilization.

For example, the first threshold may be set as 80%, that is, if Average CPU Utilization is larger than 80% for 5 minutes, then it may be determined to limit requests entering into the system.

For some system, although in terms of hardware such as in terms of CPU/memory/hard disk read and write utilization, the system does not exhibit that load thereof is very heavy and can not serve more incoming requests, in terms of software logic, the system has exhibited that load thereof is very heavy and can not serve more incoming requests, for example, there is a large number of waiting requests in an execution queue, or a large number of requests is waiting for JDBC connection. Therefore, whether to limit requests entering into the system may be determined by using system KPI such as system's average length of an execution queue or average number of requests waiting for JDBC connection.

For example, the first threshold may be set as 20, that is, if average length of an execution queue is larger than 20 for 5 minutes, then it may be determined to limit requests entering into the system.

Alternatively, the first threshold may be set as 30, that is, if average number of requests waiting for JDBC connection is larger than 30 for 5 minutes, then it may be determined to limit requests entering into the system.

Such a policy takes into account difference in systems, for different systems, whether to limit requests entering into the systems is determined by using different collected KPIs of the systems.

Wherein, at the determining step S120 and the determining module 220, after the requests entering into the system have been limited, it is determined to stop limiting the requests entering into the system if the certain collected KPI of the system is superior to a second threshold for a period of time, wherein system load indicated by the second threshold is lighter relative to the first threshold.

For example, after the requests entering into the system have been limited, such KPI as Average CPU Utilization may indicate that system load becomes lighter, which means previous limitation on requests entering into the system has came into effect, and system's stability is maintained, therefore, to make system resource to be utilized as adequately as possible, limitation on requests entering into the system should be stopped.

However, to avoid frequently switching between limiting requests entering into the system and stop limiting requests entering into the system, system load indicated by a second threshold for deciding to stop limiting requests entering into the system should be lighter than that indicated by the first threshold for deciding to limit requests entering into the system.

For example, if the first threshold is 80%, then the second threshold may be 60%, that is to say, when Average CPU Utilization is less than 60% for 5 minutes, then it is determined to stop limiting requests entering into the system.

Wherein, at the determining step S120 and the determining module 220, after the requests entering into the system have been limited, it may be determined to further limit the requests entering into the system if the collected KPI of the system is inferior to a third threshold for a period of time, wherein system load indicated by the third threshold is heavier relative to the first threshold.

For example, after the requests entering into the system have been limited, such KPI as Average CPU Utilization may indicate that, rather than being lighter, system load becomes even heavier, which means that previous limitation on requests entering into the system is not sufficient, and requests entering into the system need to be further limited to lower system load, thereby maintaining system's stability.

For example, if the first threshold is 80%, then the third threshold may be 90%, that is to say, if Average CPU Utilization is larger than 90% for 5 minutes, then it may be determined to further limit requests entering into the system, such that reject rate of requests entering into the system reaches 50%.

Of course, those skilled in the art will appreciate that, after requests entering into the system are further limited, such KPI as Average CPU Utilization indicates that, rather than being lighter, system load becomes even heavier, which means that previous further limitation on requests entering into the system is not sufficient, requests entering into the system may again be further limited to lower system load, thereby maintaining system's stability.

For example, if Average CPU Utilization is larger than 95% for 5 minutes, then it may be determined to again further limit requests entering into the system, such that reject rate of requests entering into the system reaches 100%, that is, make the system temporarily stop accepting incoming requests so as to keep the system stable.

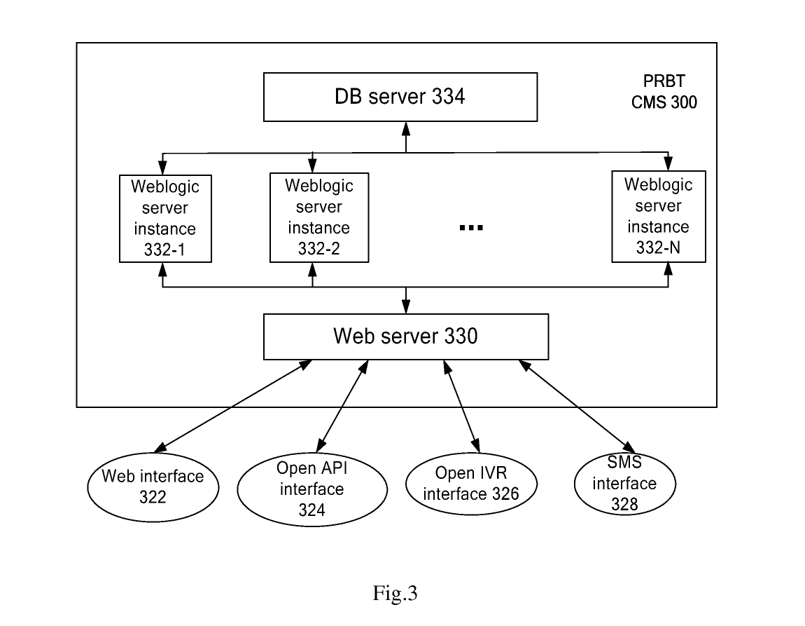

FIG. 3 illustratively shows a system in which the invention may be implemented. The system 300 shown in FIG. 3 is a Content Management System (CMS) of a Personalized Ring Back Tone (PRBT) system.

Wherein, the PRBT system enables a user of the PRBT service to set different ring back tones at different time periods for different calling numbers based on his/her own needs.

The PRBT system may include two parts, that is, PRBT-CDS (Tone Playing System) and PRBT-CMS. PRBT-CDS is responsible for receiving a call and playing personalized ring back tone to the calling party, and PRBT-CMS is responsible for managing user data and tone files for PRBT user.

The PRBT-CMS 300 as shown in FIG. 3 provides the following 4 types of interfaces for a user to interact therewith:

Web interface 322;

Open API interface 324;

Open IVR interface 326; and

SMS interface 328.

Requests from these interfaces first arrive at a Web server 330 of the PRBT-CMS 300, then are transmitted by the Web server 330 to one of Weblogic server instances 332-1, 332-2, . . . , 332-N. Wherein respective Weblogic server instances are connected to a Database (DB) server 334.

Taking into consideration that all requests entering into the PRBT-CMS 300 are transmitted to one of Weblogic server instances 332-1, 332-2, . . . , 332-N via the Web server 330, therefore, the Web server 330 is an entry point for all requests entering into the PRBT-CMS 300, so whether to limit requests entering into the PRBT-CMS 300 should be determined at the Web server 330. In other words, the foregoing determining module 220 should be implemented at the Web server 330.

In addition, the Web server 330, the Weblogic server instances 332-1, 332-2, . . . , 332-N and the DB server 334 are resources shared by all the interfaces, so KPIs thereof should be collected.

In the example as shown in FIG. 3, assume Weblogic server instances 332-1, 332-2, . . . , 332-N are primary processing device of the PRBT-CMS 300, thus, KPIs of the PRBT-CMS 300 are only related to Weblogic server instances. And in the example as shown in FIG. 3, Weblogic server instance 332-N is a management instance for managing other Weblogic server instances 332-1, 332-2, . . . Therefore, the foregoing collector 210 is implemented at the Weblogic server instance 332-N.

The collector 210 constantly collects KPIs about the PRBT-CMS 300. For example, the collector 210 constantly collects KPIs about the Weblogic server instances via a Mbean (Management Bean) class and method provided in a JMX (Java Management Extension) interface of the Weblogic server. The determining module 220 also constantly queries KPIs collected by the collector 210, and begins to reject a certain proportion of requests when it finds that a KPI matches a threshold for limiting requests entering into the system.

The KPIs collected by the collector 210 include, but not limited to, the following entries:

1) Health condition of Weblogic server: that is, current life cycle status of a Weblogic server instance;

2) Number of active server instances in N Weblogic server instances: whether each Weblogic server instance is active may be identified by sending a CMS Open API query request to respective Weblogic server instance, if a Weblogic server instance returns result of success, then that Weblogic server instance is considered to be active;

3) Number of waiting requests in an execution queue configured for each Weblogic server instance: it defines number of user requests in waiting state in a priority queue. The priority queue typically contains requests from internal subsystem and external user, the value PendingUserRequestCount is number of all external user requests;

4) Number of sockets established on each listening port of each Weblogic server instance: number of sockets currently opened by a Weblogic server instance may be obtained by using OpenSocketsCurrentCount;

5) Average load of all processors: CPU Utilization in each Weblogic server instance. Generally, from the perspective of an operator, requests from the Web interface 322, Open IVR interface 326 and SMS interface 328 are requests from end users, and requests from Open API interface 324 are requests from third party systems, to make end users keep good experience on PRBT service, priority of requests from Web interface 322, Open IVR interface 326 and SMS interface 328 should be higher than that of requests from Open API interface 324. Therefore, the operator may be configured to not limit requests from Web interface 322, Open IVR interface 326 and SMS interface 328, and only limit requests from Open API interface 324.

In addition, in this example, whether to limit requests entering into the system is determined based on the KPI of Number of sockets established on each listening port of each Weblogic server instance, the first threshold is 100, and the second threshold is 40.

That is, if maximum value of number of sockets established on a listening port is larger than 100 for 40 seconds, then requests from Open API interface 324 will be limited, and 50% of the requests will be rejected, namely, reject rate is 50%.

After requests from Open API interface 324 have been limited, if maximum value of number of sockets established on a listening port is less than 40 for 40 seconds, then limitation on requests from Open API interface 324 will be stopped.

It should be noted that, to ease the understanding of the invention, the above description has omitted some more specific technical details known to those skilled in the art but may be necessary to implement the invention.

Those skilled in the art should also appreciate that, the invention is not limited to the above described steps, and the invention also encompasses combination, sequence change etc performed on the above described steps. The ultimate scope of the invention is defined by accompany claims.

Therefore, the embodiment was chosen and described in order to best explain the principles of the invention and the practical application, and to enable others of ordinary skill in the art to understand that, on the premise of not departing from essence of the invention, all such modifications and alterations will fall into protection scope of the invention defined by claims.

Furthermore, those skilled in the art will appreciate that, steps of various methods described above may be implemented by a programmed computer. Here, some embodiments intent to cover program storage, which is machine or computer readable and encoded with machine executable or computer executable instruction program, wherein the instructions perform some or all of the steps of the above methods. The program storage may be magnetic storage medium such as magnetic disk or magnetic tape, hard disk driver or optical readable digital data storage medium. The embodiments also intent to cover a computer programmed to perform the steps of the above methods.

1. A traffic control method, comprising:
collecting key performance indexes of a system; and
determining whether to limit requests entering into the system based on the collected key performance indexes of the system, and it is determined that the requests entering into the system will be limited when a certain collected key performance index of the system is inferior to a first threshold for a period of time.

2. The method of claim 1, wherein, for requests entering into the system from different interfaces, whether to limit the requests entering into the system from respective interfaces is determined by using different collected key performance indexes of the system.

3. The method of claim 1, wherein, for requests entering into the system from different interfaces, whether to limit the requests entering into the system from respective interfaces is determined by using same collected key performance indexes of the system but by using different thresholds.

4. The method of claim 1, wherein, for different systems, whether to limit the requests entering into the systems is determined by using different collected key performance indexes of the systems.

5. The method of claim 1, wherein, after the requests entering into the system have been limited, it is determined to stop limiting the requests entering into the system if the certain collected key performance index of the system is superior to a second threshold for a period of time, wherein system load indicated by the second threshold is lighter relative to the first threshold.

6. The method of claim 1, wherein, after the requests entering into the system have been limited, it is determined to further limit the requests entering into the system if the certain collected key performance index of the system is inferior to a third threshold for a period of time, wherein system load indicated by the third threshold is heavier relative to the first threshold.

7. The method of claim 1, wherein limiting the requests comprises randomly rejecting a certain proportion of the requests.

8. A traffic control apparatus, comprising:
collector for collecting key performance indexes of a system; and
determining module for determining whether to limit requests entering into the system based on the collected key performance indexes of the system, and determining that the requests entering into the system will be limited when a certain collected key performance index of the system is inferior to a first threshold for a period of time.

9. The apparatus of claim 8, wherein, for requests entering into the system from different interfaces, the determining module determines whether to limit the requests entering into the system from respective interfaces by using different collected key performance indexes of the system.

10. The apparatus of claim 8, wherein, for requests entering into the system from different interfaces, the determining module determines whether to limit the requests entering into the system from respective interfaces by using same collected key performance indexes of the system but by using different thresholds.

11. The apparatus of claim 8, wherein, for different systems, the determining module determines whether to limit the requests entering into the systems by using different collected key performance indexes of the systems.

12. The apparatus of claim 8, wherein, after the requests entering into the system have been limited, the determining module determines to stop limiting the requests entering into the system if the certain collected key performance index of the system is superior to a second threshold for a period of time, wherein system load indicated by the second threshold is lighter relative to the first threshold.

13. The apparatus of claim 8, wherein, after the requests entering into the system have been limited, the determining module determines to further limit the requests entering into the system if the certain collected key performance index of the system is inferior to a third threshold for a period of time, wherein system load indicated by the third threshold is heavier relative to the first threshold.

14. The apparatus of claim 8, wherein limiting the requests comprises randomly rejecting a certain proportion of the requests.
